(19) United States
(12) Patent Application Publication
(10) Pub. No.: US 2018/0131099 A1
(43) Pub. Date: May 10, 2018

(54) STRUCTURE BETWEEN RADAR AND FASCIA

(71) Applicant: GM Global Technology Operations LLC, Detroit, MI (US)

(72) Inventors: Kevin Geary, Santa Monica, CA (US); Arthur Bekaryan, Northridge, CA (US); Hyok Jae Song, Oak Park, CA (US); Igal Bilik, Rehovot (IL)

(21) Appl. No.: 15/573,173

(22) PCT Filed: May 13, 2015
(86) PCT No.: PCT/US2015/030546

§ 371 Date: Nov. 10, 2017

(51) Int. Cl. H01Q 15/00; H01Q 1/42; H01Q 1/32; G01S 7/03; G01S 13/93

(52) U.S. Cl. CPC H01Q 15/002; H01Q 1/42; G01S 2007/027; G01S 7/038; G01S 13/931; H01Q 1/3233

(57) ABSTRACT

A system and a method of arranging a radar transceiver unit within a system are described. The system includes a radar transceiver including an antenna array to transmit and receive energy within a frequency range, and a fascia to cover the antenna array. The system also includes a structure disposed between the antenna array and the fascia, the structure including a first base on a side closest to the antenna array and a second base on a side closest to the fascia, wherein the first base is smaller than the second base and the structure has a shape such that a series of cross sections from the first base to the second base indicate a gradual increase in size.

### FIELD OF THE INVENTION

The subject invention relates to a structure in the air gap between a radar antenna array and a fascia.

### BACKGROUND

In certain radar applications, the radar system is mounted behind a fascia. Exemplary applications include airborne, automotive (e.g., cars, construction equipment), and ship-based systems, for example. For example, in an automotive application, the radar may be mounted behind the plastic portion of an automobile bumper. Typically, there is an air gap between radiating elements of the radar system and the fascia. The impedance mismatch at the air-to-fascia interface results in loss of energy through both reflections at the interfaces and material absorption and scattering loss as the energy propagates through the fascia. When this air gap is an ideal distance, minimal two-way propagation loss of energy transmitted and received by the radar is achieved (e.g., as low as approximately 0.2 decibels (dB)). However, over a large number of units (e.g., automobiles), achieving the ideal air gap becomes impractical, and achieving the same (even non-ideal) gap consistently becomes difficult. As a result, characterizing and accounting for the propagation loss, along with beam pattern distortions of the transmitted radar beam, becomes challenging. When paint layers, which contribute to attenuation and scattering of radar energy, are applied to the outer fascia surface, the issue may be exacerbated with additional variances. As noted above, the variability in the propagation loss may require calibration, which is technically challenging, or result in suboptimal performance. Alternately, the need to reduce variability among units that include the radar behind the fascia may lead to strict tolerances in fabrication of the fascia and require strict attention to the placement of the radar system given the strong correlation of location on performance. To address the issues discussed above, it is desirable to reduce the variation in electromagnetic reflection and transmission losses based on variations in physical and electrical properties of fascia and any paint layers.

### SUMMARY OF THE INVENTION

In one exemplary embodiment of the invention, a system includes a radar transceiver including an antenna array configured to transmit and receive energy within a frequency range; a fascia configured to cover the antenna array; and a structure configured to be disposed between the antenna array and the fascia, the structure including a first base on a side closest to the antenna array and a second base on a side closest to the fascia, wherein the first base is smaller than the second base and the structure has a shape such that a series of cross sections from the first base to the second base indicate a gradual increase in size.

In another exemplary embodiment of the invention, a method of arranging a radar transceiver unit within a system includes disposing an antenna array of the radar transceiver unit within the system; disposing a fascia on a side of the antenna array such that a first side of the fascia is closest to the side of the antenna array; and disposing a structure between the side of the antenna array and the first side of the fascia, the structure including a first base closest to the side of the antenna array and a second base closest to the first side of the fascia, the first base being smaller than the second base and a shape of the structure being such that a series of cross sections from the first base to the second base indicate a gradual increase in size.

The above features and advantages and other features and advantages of the invention are readily apparent from the following detailed description of the invention when taken in connection with the accompanying drawings.

### BRIEF DESCRIPTION OF THE DRAWINGS

Other features, advantages and details appear, by way of example only, in the following detailed description of embodiments, the detailed description referring to the drawings in which:

FIG. 1 shows an exemplary system that includes a structure between a radar antenna array and a fascia;

FIG. 2 shows another exemplary system that includes a structure between a radar antenna array and a fascia;

FIG. 3 shows yet another exemplary system that includes a structure between a radar antenna array and a fascia;

FIG. 4 illustrates a structure according to an exemplary embodiment;

FIG. 5 shows part of a view of a set of exemplary structures from the perspective of the radar antenna array toward the fascia;

FIG. 6 illustrates a structure according to another exemplary embodiment; and

FIG. 7 shows processes of a method of arranging a radar transceiver unit within a system according to embodiments.

### DESCRIPTION OF THE EMBODIMENTS

The following description is merely exemplary in nature and is not intended to limit the present disclosure, its application or uses. It should be understood that throughout the drawings, corresponding reference numerals indicate like or corresponding parts and features.

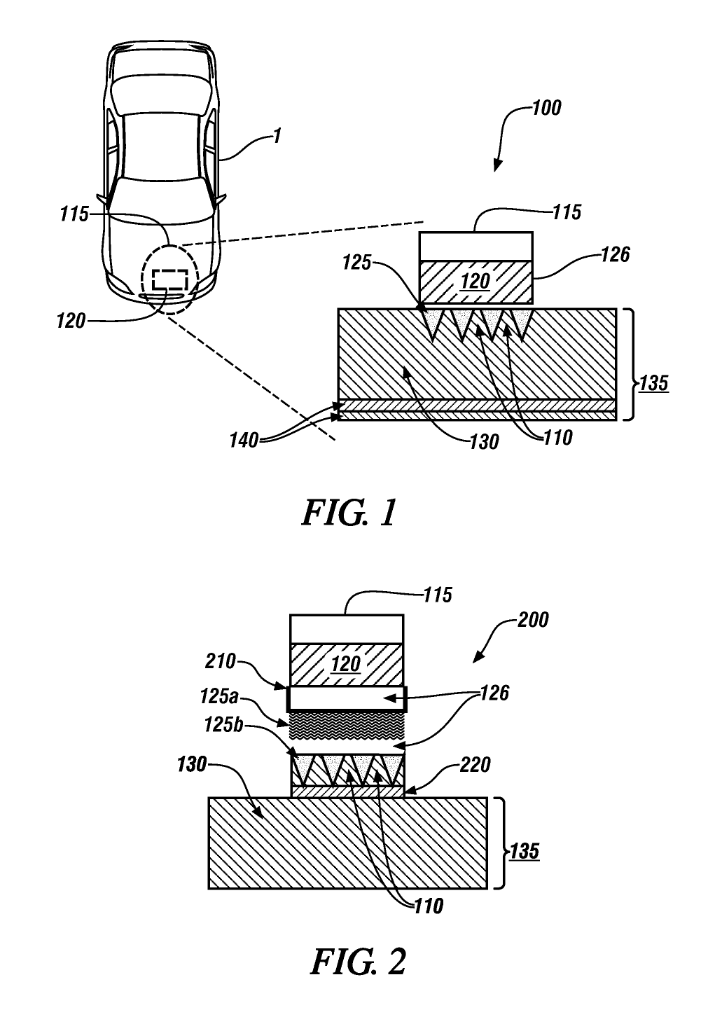

In accordance with an exemplary embodiment of the invention, a system 100 is shown in FIG. 1 that includes structures 110 between a radar antenna array 120 and a fascia 130. Structure 110 may refer to the collection of shapes (as in the discussion of FIGS. 1-3) or may refer to each shape individually (as in the discussion of FIGS. 4-6). The radar antenna array 120 is part of a radar transceiver unit 115 that transmits and receives energy at a selected frequency range. The radar antenna array 120 may be housed together with other components of the radar transceiver unit 115, as shown in FIG. 1, or may be coupled to other components in alternate embodiments. As noted above, the system 100 may be part of a number of applications. In the exemplary case of the automotive application, for example, the radar transceiver unit 115 may operate in the range of 77 GHz. The radar antenna array 120 is typically housed in a cover (i.e. radome 210 (FIG. 2)). The fascia 130 may also act as a cover or concealment for the radar antenna array 120 to protect from environmental factors or for cosmetic purposes. According to the exemplary embodiment shown in FIG. 1, the structures 110 are molded or machined into the fascia 130 that is separated from a radar antenna array 120 by an air gap 126. The air gap 126 and the space around the structures 110 may be filled completely or partially (as shown) with spacer material 125. This spacer material 125 may be structural foam or other material with a known dielectric constant and low dielectric loss at the frequencies of interest. The fascia 130, which may be the plastic portion of a bumper of the automobile 1 as shown in the exemplary embodiment of FIG. 1, may have paint layers 140 on its surface. While two paint layers 140 are shown for explanatory purposes, any number of paint layers 140 is contemplated. The fascia 130 may alternately be any other part of an automobile 1 in the exemplary automotive application, a radome, or any non-metallic material exhibiting low dielectric loss at the frequencies of interest.

In the embodiment of FIG. 1, the molded bumper 130 and paint layers 140 are referred to collectively as the material 135. Without the structure 110, as the thickness of the material 135 changes or the dielectric constant or dielectric loss associated with the fascia 130 or paint layers 140 changes, the two-way propagation loss generally shifts. In addition, for each given thickness of the material 135 and dielectric constant and dielectric loss, the two-way propagation loss varies. This variation in addition to the general change leads to some of the challenges discussed above. The placement of the structure 110 between the material 135 and the radar antenna array 120 results in a near constant two-way propagation loss for the energy associated with the radar antenna array 120 with respect to variations in the thickness of the material 135. The variation in two-way propagation loss may be 0.1 decibels (dB) or less when the structure 110 is used. The structure 110 is further detailed below.

In accordance with another exemplary embodiment of the invention, a system 200 is shown in FIG. 2 that includes structures 110 between a radar antenna array 120 and a fascia 130. As noted above, the structure 110, according to the exemplary embodiment shown in FIG. 1, is molded or machined into the fascia 130. The structure 110, according to the exemplary embodiment shown in FIG. 2, is machined as a stand-alone component that is attached onto the fascia 130 with an adhesive 220, for example, and arranged between the radar antenna array 120 and fascia 130. A radome 210 is additionally illustrated as a cover to the radar transceiver unit 115. An air gap 126 remains between a first type of spacer material 125a and a second type of spacer material 125b between the structures 110, as shown in FIG. 2. In alternate embodiments, there may be no remaining air gap 126, and only one or more than two spacer materials 125 may be used.

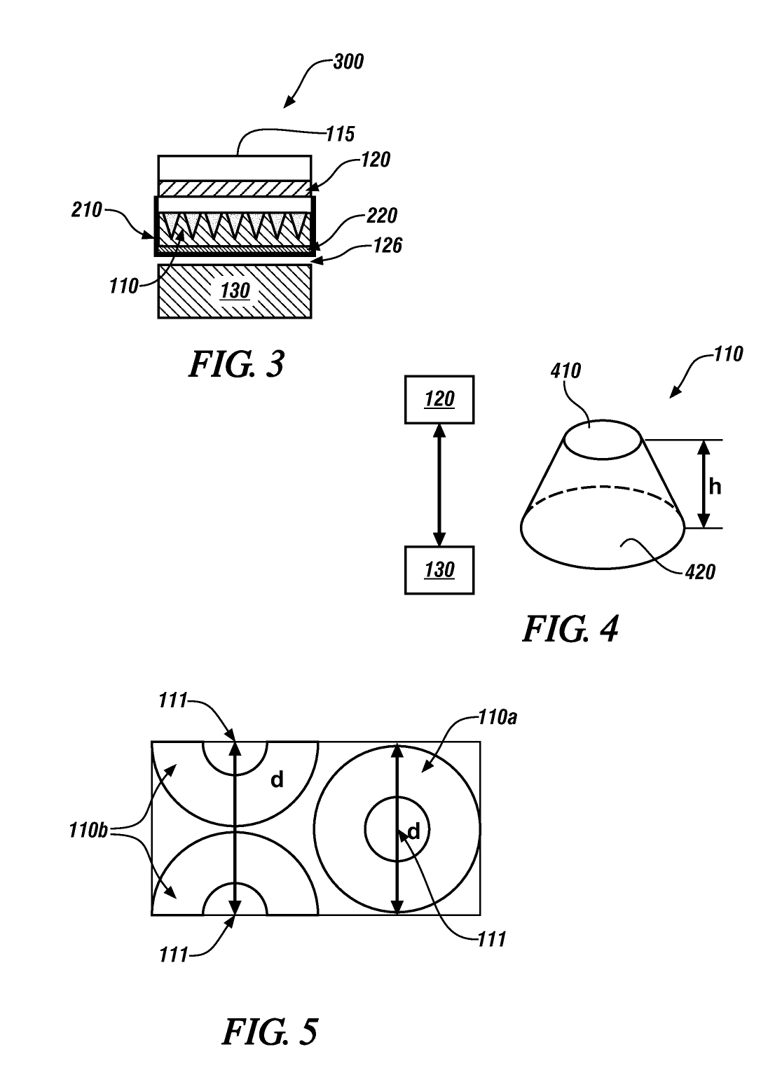

In accordance with yet another embodiment of the invention, a system 300 is shown in FIG. 3 that includes structure 110 between a radar antenna array 120 and a fascia 130. In the exemplary embodiment shown in FIG. 3, the structure 110 is attached inside the radome 210 by an adhesive 220, for example. As in all of FIGS. 1-3, the wider part of the structure 110 is closer to the fascia 130 while the narrower part of the structure 110 is closer to the radar antenna array 120. This arrangement, as further discussed below, provides non-variance in two-way propagation loss regardless of variance in the air gap 126 or fascia 130 thickness.

FIG. 4 illustrates a structure 110 according to an exemplary embodiment. The structure 110 includes a first base 410 on the side closest to the radar antenna array 120 (as indicated) and a second base 420, having a larger diameter than the first base 410, on the side closest to the fascia 130. As the figure indicates, the exemplary structure 110 is a truncated cone and there is a gradual increase in diameter from base 410 to base 420. That is, a series of cross sectional views starting at base 410 and ending at base 420 would indicate a gradual increase in size. An exemplary base 410-to-base 420 diameter ratio may be 0.5, for example. Exemplary dimensions for the structure shown in FIG. 4 may be 1.75 millimeters (mm) for the diameter of the base 420 and 1 mm for the height h when the structure 110 is used in the exemplary automotive application shown in FIG. 1, for example. As noted above, the feature of the arrangement that provides the desired non-variance in two-way propagation loss in view of a variance in material 135 thickness is the positioning of the wider base 420 closer to the fascia 130 and the smaller base 410 closer to the radar antenna array 120. As FIG. 1 indicates, multiple structures 110 may be arranged between the radar antenna array 120 and the fascia 130.

FIG. 5 shows part of a view of a set of exemplary structures 110 from the perspective of the radar antenna array 120 toward the fascia 130. The structures 110 are arranged in a staggered manner (as opposed be being side-by-side). This staggering may be periodic or non-periodic. One full structure 110a and two partial structures 110b are shown in FIG. 5. The staggered arrangement of the structures 110 is obscured by the perspective of FIGS. 1-3. The staggered arrangement ensures that all areas of high absorption are eliminated while retaining the constant propagation loss with respect to variation in the thickness of the material 135. As shown in FIG. 5, the distance between the center points 111 of the two partial structures 110b is the same as the diameter d of the structure 110a. Other arrangements among the structures 110, including non-periodic arrangements, are possible, but the embodiment shown may minimize two-way propagation loss through the fascia 130 for both normal incidence and oblique incidence angles of energy into and out of the radar antenna array 120.

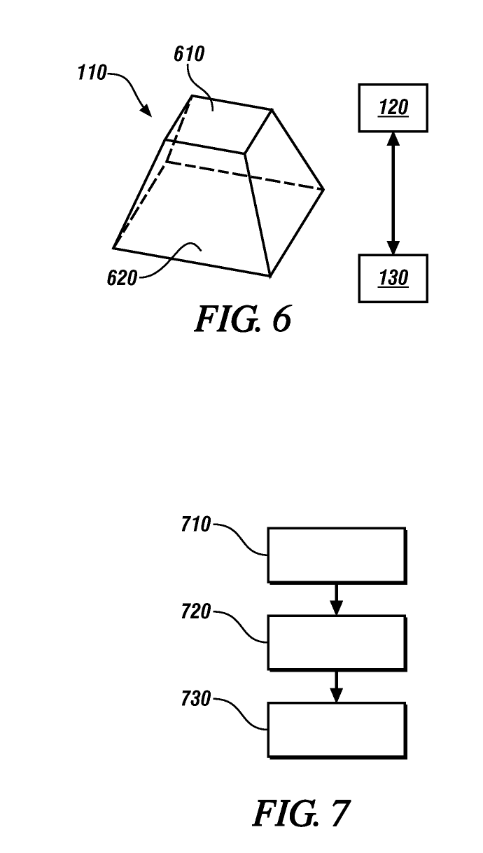

FIG. 6 illustrates a structure 110 according to another exemplary embodiment. The structure 110 according to the present embodiment is a truncated pyramid. The base 610 of the structure 110 that is closest to the radar antenna array 120 is smaller in width than the base 620 that is closest to the fascia 130, with a gradual change in width between the two bases 610, 620. The ratio between the widths of the bases 610 to 620 may be 0.5, and exemplary dimensions of the structure 110 shown in FIG. 6 may be a base 620 width of 1.5 mm and a height of 1 mm in the exemplary automotive application shown in FIG. 1. As with the dimensions discussed with reference to FIG. 3, these exemplary dimensions are only intended to convey exemplary relative dimensions and are not to be construed as limiting the dimensions of structures 110 used in different applications with fascia 130 and radar antenna arrays 120 of different dimensions. As FIG. 1 indicates, an air gap 126 may still exist between the structure 110 and either or both of the radar antenna array 120 and the fascia 130. That is, not only may the structure 110 not be molded into the fascia 130 (as in FIGS. 2 and 3) but the structure 110 may also not be in contact with the radar antenna array 120. As FIG. 1 also indicates, a spacer material 125 may fill the air gap 126. This spacer material may be structural foam or other material with a known constant and low dielectric loss at the frequencies of interest. The composition of the structure 110 may be the same as the composition of the fascia 130. This would be the case when the structure 110 is molded into the fascia 130, for example. The structure 110 may alternatively be any material exhibiting low dielectric loss at the frequencies of interest, which may be microwave or millimeter wave frequencies, for example.

FIG. 7 shows processes of a method of arranging a radar transceiver unit 115 with a system. In the exemplary embodiment shown in FIG. 1, the system is an automobile 1. At block 710, the method includes a process of disposing the radar antenna array 120 within the system. The method also includes the process, at block 720, of disposing a fascia 130 on a side of the radar antenna array 120, as shown in the exemplary arrangement of FIGS. 1 and 2, for example. At block 730, the process of disposing a structure 110 between the radar antenna array 120 and the fascia 130 may include machining or molding the structure from a side of the fascia 130 that is closest to the radar antenna array 120 as shown in FIG. 1, for example. In alternate embodiments (see e.g., FIG. 2), disposing the structure 110 may include disposing a stand-alone part that may be separated from one or both of the radar antenna array 120 and fascia 130 by an air gap 126. This air gap 126 may be filled with spacer material 125. The structure 110 generally has the shape discussed with reference to FIGS. 1-4 and 6. Multiple structures 110 may be disposed as part of the process at block 730. The multiple structures 110 are arranged in a staggered pattern as discussed with reference to FIG. 5.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed, but that the invention will include all embodiments falling within the scope of the application.

What is claimed is:

1. A system comprising:
a radar transceiver including an antenna array configured to transmit and receive energy within a frequency range;
a fascia configured to cover the antenna array; and
a structure configured to be disposed between the antenna array and the fascia, the structure including a first base on a side closest to the antenna array and a second base on a side closest to the fascia, wherein the first base is smaller than the second base and the structure has a shape such that a series of cross sections from the first base to the second base indicate a gradual increase in size.

2. The system according to claim 1, wherein the frequency range is centered at 77 gigahertz (GHz).

3. The system according to claim 1, wherein the structure is molded or machined from the fascia.

4. The system according to claim 1, wherein the structure is machined as a separate component than the fascia.

5. The system according to claim 1, wherein the structure has a different material composition than the fascia.

6. The system according to claim 1, wherein the structure is disposed such that there is an air gap between the structure and the antenna array or the fascia.

7. The system according to claim 6, wherein the air gap is filled with a spacer material.

8. The system according to claim 1, wherein a ratio of a dimension of the first base to the second base is 0.5.

9. The system according to claim 1, wherein a plurality of the structures are arranged between the antenna array and the fascia.

10. The system according to claim 9, wherein the plurality of the structures are arranged in a staggered periodic or non-periodic pattern.

11. The system according to claim 1, wherein the fascia includes one or more layers of paint on a surface opposite a closest surface to the second base on the structure.

12. A method of arranging a radar transceiver unit within a system, the method comprising:
disposing an antenna array of the radar transceiver unit within the system;
disposing a fascia on a side of the antenna array such that a first side of the fascia is closest to the side of the antenna array; and
disposing a structure between the side of the antenna array and the first side of the fascia, the structure including a first base closest to the side of the antenna array and a second base closest to the first side of the fascia, the first base being smaller than the second base and a shape of the structure being such that a series of cross sections from the first base to the second base indicate a gradual increase in size.

13. The method according to claim 12, wherein the disposing the structure includes molding the structure from the first side of the fascia.

14. The method according to claim 12, wherein the disposing the structure includes adhering the structure that is machined as a stand-alone component.

15. The method according to claim 12, further comprising leaving an air gap between the structure and the side of the antenna array or the first side of the fascia.

16. The method according to claim 15, further comprising filling the air gap with a spacer material.

17. The method according to claim 12, further comprising disposing a plurality of the structures between the side of the antenna array and the first side of the fascia.

18. The method according to claim 17, wherein the disposing the plurality of the structures is in a staggered periodic or non-periodic pattern.

19. The method according to claim 12, wherein the disposing the fascia includes disposing a second side of the fascia that includes one or more layers of paint on an opposite side of the first side of the fascia.

20. The method according to claim 12, wherein the arranging the radar transceiver unit within the system includes arranging the radar transceiver unit within an automobile.
